(19) United States
(12) Patent Application Publication
(10) Pub. No.: US 2017/0337335 A1
(43) Pub. Date: Nov. 23, 2017

(54) SYSTEMS AND METHODS FOR FULFILLING MEDICAL ORDERS

(71) Applicants: Blake Squires, Akron, OH (US); John Maruna, Bay Village, OH (US)

(72) Inventors: Blake Squires, Akron, OH (US); John Maruna, Bay Village, OH (US)

(21) Appl. No.: 15/599,905

(22) Filed: May 19, 2017

Related U.S. Application Data
(60) Provisional application No. 62/338,677, filed on May 19, 2016.

(51) Int. Cl. G06F 19/00; G06Q 50/24; G06Q 50/22

(52) U.S. Cl. CPC G06F 19/34; G06Q 50/24; G06F 19/3418; G06F 19/324; G06F 19/322; G06F 19/326; G06F 19/3443; G06Q 50/22

(57) ABSTRACT

The innovation disclosed and claimed herein, in one aspect thereof, comprises systems and methods of facilitating prescription orders for medical supplies. A prescription portal is provided to a user. A digital prescription is populated with digital prescription information using the prescription portal. A standardized prescription order is generated from the digital prescription information. The standardized prescription order is communicated to a fulfillment entity. The fulfillment entity dispenses the medical supplies to a patient according to the prescription order.

### CROSS-REFERENCE TO RELATED APPLICATIONS

This application claims the benefit of U.S. Provisional Patent Application, Ser. No. 62/338,677 entitled “SYSTEM AND METHOD OF ORDERING PRODUCTS”, filed on May 19, 2016. The entirety of the above-noted application is incorporated by reference herein.

### BACKGROUND

Medical supply ordering includes complex workflows and processes. Much of the process is filling out prescription orders by hand. However, current prescriptions are not effective. Oftentimes, the prescription orders contain missing or incomplete information. Collecting the missing information can take upwards of 60 days. It has been observed that only about 30% of current prescriptions are actionable without human intervention to collect missing information.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of facilitating prescription orders for medical supplies. A prescription portal is provided to a user. A digital prescription is populated with digital prescription information using the prescription portal. A standardized prescription order is generated from the digital prescription information. The standardized prescription order is communicated to a fulfillment entity. The fulfillment entity dispenses the medical supplies to a patient according to the prescription order.

A system of the innovation can include a portal component that provides a prescription portal to a user. The system includes a population component that populates a digital prescription with prescription information using the prescription portal. The system further includes an order component that generates a standardized prescription order from the digital prescriptions and a network component that communicates the standardized prescription order to a fulfillment entity. The fulfillment entity dispenses the medical supplies to a patient according to the prescription order.

In aspects, the subject innovation provides substantial benefits in terms of ordering medical supplies that use a physician's prescription. One advantage resides in a quicker dispensation of medical supplies due to a lack of missing information. Another advantage resides in streamlined prescription input by the physician which reduces paperwork and workload for the physician.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example component diagram of a system that facilitates prescription orders.

FIG. 2 illustrates an example component diagram of a system that facilitates prescription orders.

FIG. 3 illustrates an example component diagram of a population component.

FIG. 4 illustrates a method for facilitating prescription orders.

FIG. 5 illustrates a computer-readable medium or computer-readable device comprising processor-executable instructions configured to embody one or more of the provisions set forth herein, according to some embodiments.

FIG. 6 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” “screenshot,” “view,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

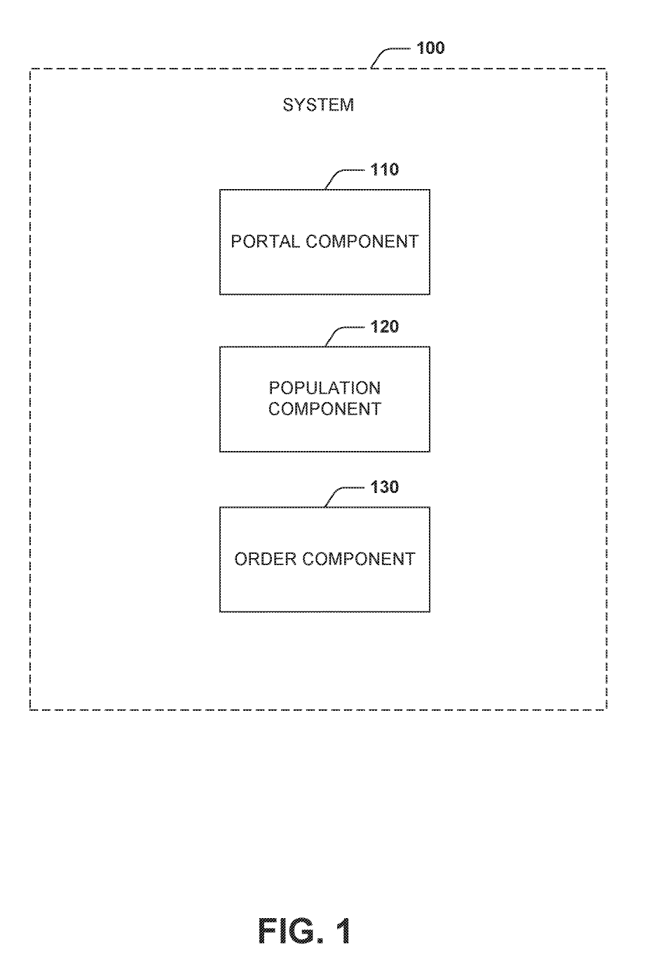

FIG. 1 illustrates a system 100 for facilitating prescription orders. For example, the system 100 can receive input from a user regarding a new, current, or refill prescription request to be given to a patient or person designated to receive a prescription. In some embodiments, the user may be a physician, physician assistant, nurse, a person under the supervision of a physician, and/or the like.

The system 100 includes a portal component 110 that provides a prescription portal to a user. The portal component 110 can present an interface, views, and/or screens to a user to create a digital prescription. In some embodiments, the portal component 110 can provide an environment through which the user may manipulate, provide input, navigate, and/or the like. In some embodiments, the portal component 110 can provide a series of screens or views to the user for various functions, inputs, tasks, and/or the like.

The system 100 includes a population component 120 that populates a digital prescription with prescription information using the prescription portal 110. The population component 120 can receive information from various data sources. In some embodiments, the population component 120 may receive information from user input, patient databases, electronic medical records, insurance provides, pharmaceutical databases, pharmacy databases, and/or the like. The population component 120 can parse the data from the data sources to determine data types or tags, redundancies, changes, and/or the like.

In some embodiments, the population component 120 interfaces with the views presented by the portal component 110. The population component 120 can input the relevant information into a plurality of fields presented within a presented view. For example, a view can be presented to the user for a digital prescription. The population component 120 can determine the fields in the view and populate the fields with the relevant information. In other embodiments, the user populates some or all of the fields in the view via the population component 120.

The system 100 includes an order component 130 that generates a standardized prescription order from populated digital prescription information. The order component 130 receives the populated digital prescription information. The order component 130 can convert the information into a standardized prescription order. In some embodiments, the order component 130 has many different standardized forms that vary according to difference pharmacies, insurance providers, health systems, hospitals, and/or the like. Once the standardized prescription order is generated, it can be sent, printed, communicated, or forwarded to a fulfillment entity, an approval entity, and/or the patient.

In some embodiments, the portal component 110 can present a view to the user to receive a physician signature via the portal component 110. The physician may digitally sign (i.e. e-sign) the prescription order to finalize the standardized prescription order. In some embodiments, the user is not the physician but a nurse, physician assistant, and/or the like. In this embodiment, the physician may receive an alert via email, text, and/or the like that requests a signature or links to the unsigned prescription order in the portal component 110 for the prescription order. The unsigned prescription order may be saved in the system 100 to await the physician signature. In another embodiment, the unsigned prescription order may be printed and physically signed and then scanned into the system 100.

In some embodiments, the system 100 provides a mode for a user to approve prescription renewals. The physician may receive an alert via email, text, and/or the like that requests the physician visit the portal component 110 for a signature or links to the unsigned renewal prescription order in the portal component 110 for the renewal prescription order. The unsigned renewal prescription order may be saved in the system 100 to await the physician signature. In one embodiment, the alert may include a link that opens a renewal view to the user within the portal component 110. The physician can view and sign the renewal prescription order to be fulfilled.

In some embodiments, the system 100 can be integrated into an electronic medical record system or electronic health record system. The integration can be seamless such that information is shared between systems fluidly. In some embodiments, the integration may be presented with API call/response methods, datafeeds, and/or the like.

In some embodiments, the patient may have access to their account information within the system 100 where the portal component 110 may present patient specific views the patient. The patient specific views may be prescription order history, upcoming renewals, pending orders, and/or the like. In other embodiments, the patient registers with the system 100 before accessing the patient specific views and information.

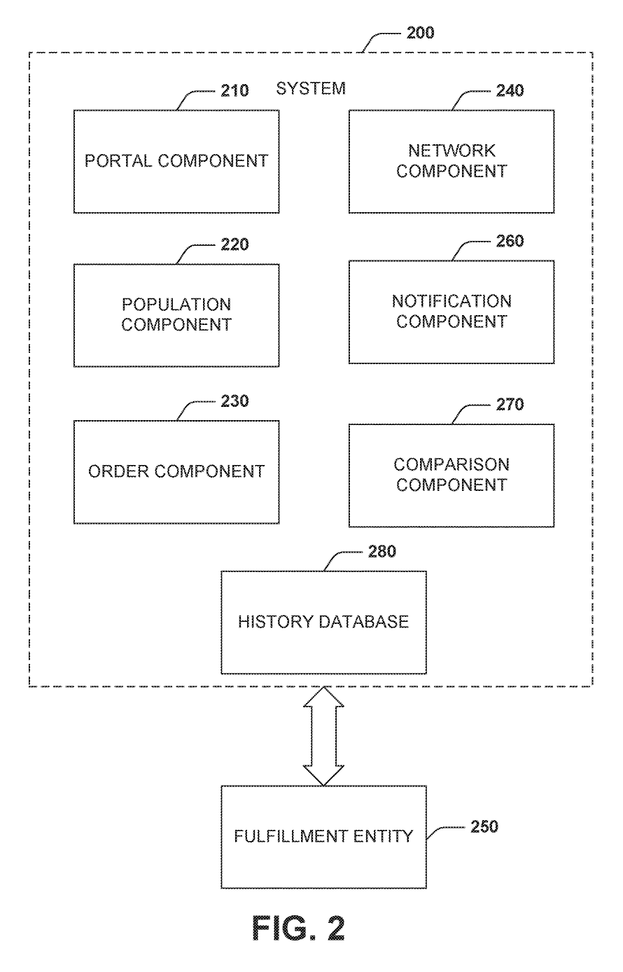

FIG. 2 illustrates a detailed component diagram of a system 200 that further facilitates prescription orders. The system 200 can receive input from a user regarding a new, old, refill, prescription request to be given to a patient or person designated to receive a prescription. In some embodiments, the user may be a physician, physician assistant, nurse, a person under the supervision of a doctor, and/or the like.

The system 200 includes a portal component 210 that provides a prescription portal to a user. The portal component 210 can present an interface, views, and/or screens to a user to create a digital prescription having digital prescription information. In some embodiments, the portal component 210 can provide an environment through which the user may manipulate, provide input, navigate, and/or the like. In some embodiments, the portal component 210 can provide a series of screens or views to the user for various functions, inputs, tasks, and/or the like.

The system 200 includes a population component 220 that populates a digital prescription with prescription information using the prescription portal 210. The population component 220 can receive information from many sources. In some embodiments, the population component 220 may receive information from user input, patient databases, electronic medical records, insurance provides, pharmaceutical databases, pharmacy databases, and/or the like. The population component 220 can parse the data from the data sources to determine data types or tags, redundancies, changes, and/or the like. The population component 220 is described in further detail below.

In some embodiments, the population component 220 interfaces with the views presented by the portal component 210. The population component 220 can input the relevant information into a plurality of fields presented within a presented view. For example, a view can be presented to the user for a digital prescription. The population component 220 can determine the fields in the view and populate the fields with the relevant information. In other embodiments, the user populates some or all of the fields in the view via the population component 220.

The system 200 includes an order component 230 that generates a standardized prescription order from populated digital prescription information. The order component 230 receives the populated digital prescription information. The order component 230 can convert the information into a standardized prescription order. In some embodiments, the order component 230 has many different standardized forms that vary according to difference pharmacies, insurance providers, health systems, hospitals, and/or the like.

The system 200 includes a network component 240. The network component 240 can be a mobile network, wired LAN, wireless LAN, an internet network, or the like to transmit communications. The network component 240 can be a corporation wide network that provides online services and/or access to corporate sites and/or information. Once the standardized prescription order is generated by the order component 130, the standardized prescription order can be communicated via the network component 240 to a fulfillment entity 250, approval entity, and/or the patient.

The network component 240 can send the standardized prescription order to the fulfillment entity 250. The fulfillment entity 250 can be a medical supply provider, a third party pharmacy, a hospital pharmacy, an online pharmacy, an insurance provider affiliated pharmacy, and/or the like. The fulfillment entity 250 fills the standardized prescription order into a physical prescription unit. In some embodiments, the fulfillment entity 250 can dispense the prescription unit to a patient or patient representative. In other embodiment, the fulfillment entity 250 can mail the prescription unit to the patient's address.

In some embodiments, when a prescription order is sent, the portal component 210 may prompt the user as to whether the user would like to enter a subsequent prescription for the same patient. If the user selects yes, the patient information maybe auto-populated by the population component 220 into a new digital prescription and the user can input new or different prescription orders for the patient.

In some embodiments, when a digital prescription or a standardized prescription is generated or communicated, a notification component 260 generates an alert to the patient associated with the prescription. The notification component 260 can communicate the alert to the patient. In some embodiments, the notification component 260 communicates the alert over a transmission server to a patient device via the network component 240. The alert may be a text message, SMS/MMS message, email, automated phone message, and/or the like. In some embodiments, the patient device includes an application associated with the system 200. The alert may be communicated to the patient via the application through an API call/response and/or the like.

The system 200 includes a comparison component 270. The comparison component 270 checks the digital prescription information from the population component against a patient's prescription history for potential prescription conflicts. The prescription history can be stored in a history database 280. For example, the digital prescription information input by a user calls for Medication X. Medication X conflicts with Medication Y. The comparison component 270 can check the prescription history to see if Medication Y has been prescribed to the patient and/or the patient is currently taking Medication Y such that a potential harmful interaction between medications could occur. The comparison component 270 can notify the user (e.g. a prescriber) of the conflict via the notification component 260, portal component 210, or the like.

In some embodiments, the history database 280 can be updated once a digital prescription or a standardized prescription order is generated. The history database associates the prescription (or medication) with the patient and stores the association and relevant information. In another embodiment, the history database 280 stores insurance information of the patient. In this embodiment, the history database 280 can check the prescription whether the patient's insurance has approved the prescription to be covered by the insurance. If the insurance has not given approval, an alert can be generated and presented to the user, where the user can prescribe a different medical supply or medication.

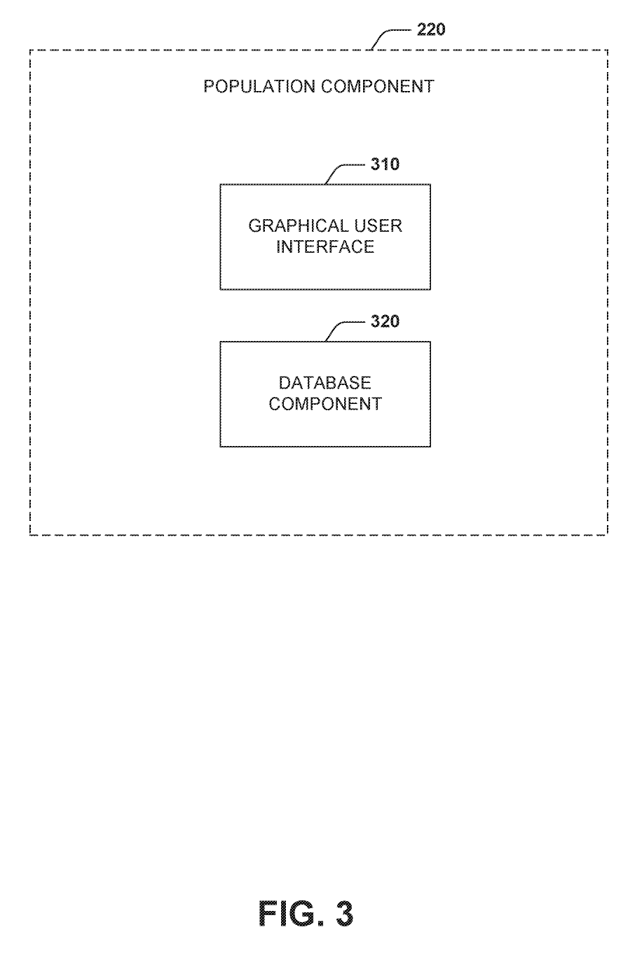

FIG. 3 illustrates a component diagram of a population component 220. The population component 220 provides digital prescription information to the portal component 210. The population component 220 can receive information from various data sources. The population component 220 includes a graphical user interface (GUI) component 310. The GUI component 310 may receive information from a user input. The GUI component 310 can be manipulated by the user to receive input from the user to fill out fields in the view presented by the portal component 210. In some embodiments, the GUI component 310 can be a keyboard, mouse, touch screen, voice command, and/or the like to receive input from a user. In some embodiments, the GUI component 310 can be manipulated to have the portal component 210 present a medical documentation upload view. The user may manually upload medical documentation via the upload view. The medical documentation can be in a digital file format such as a pdf file, electronic medical chart, and/or the like.

In some embodiments, the population component 220 can include a database component 320. The database component 320 can mine patient information databases, insurance provider databases, electronic medical record systems, electronic health record systems, pharmaceutical databases, pharmacy databases, and/or the like to receive information regarding the patient and/or medical supplies. The database component 320 can facilitate entering information into the view presented by the portal component by auto-populating the fields for which the information is known.

For example, when the database component 320 knows a patient's identity, the database component 320 can access a patient database to receive date of birth, address, phone number, and/or the like and populate the information into the view. In some embodiments, the database component 320 can search a drug database, where the drug database can provide common prescription amounts or use instructions to the database component 320. The database component 320 can auto-populate the instructions field of the digital prescription. In some embodiments, the recommended instructions may be presented to the user in a dialog box for confirmation or editing before populating the instructions field.

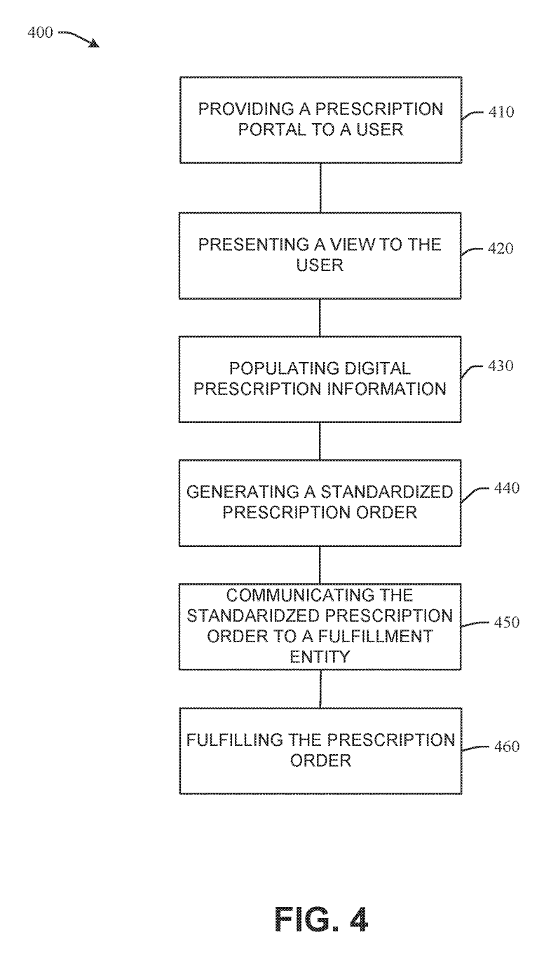

With reference to FIG. 4, example methods 400 are depicted for authenticating a user to verify identity. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 400 are described in conjunction with a specific example is for explanation purposes.

FIG. 4 illustrates a method 400 for facilitating prescription orders for patients. At 410, a prescription portal is provided to a user. For example, a user is a physician that wants to complete a prescription for a patient. The physician accesses the portal via a computer, tablet, mobile phone, and/or other devices with a login or other credentials. At 420, a series of views are presented to the user. In the example, the prescription portal includes a series of functional views to be presented to the user; the functional views provide different sets of information or tasks for the user to complete to facilitate a digital prescription.

At 430, digital prescription information is populated. The digital prescription information can be provide discreetly by the user or be auto-populated with information known about the patient and/or the prescription. In the example, the physician navigates to the digital prescription view. In the view, information can be input in different datafields in the view by the physician. The datafields could be auto-populated with information known about the patient such as insurance information, address, and/or the like. In this embodiment, the physician may only input medical supply or medication information. For example, the physician prescribes disposable medical supplies such as a set of ostomy supplies for the patient. Medical instructions for the ostomy supplies may be auto-populated in the digital prescription information.

At 440, a standardized prescription order is generated. The digital prescription information is converted and input into a form that can be accepted by a fulfillment entity. The standardize prescription order may vary according to hospital system, pharmacy, or fulfillment entity. In the example, the fulfillment entity for the ostomy supplies has a distinct order form. The digital prescription information is converted into the fulfillment entity's order form.

At 450, the standardized prescription order is communicated to the fulfillment entity. At 460, the prescription order is filled by the fulfillment entity. In the example, the prescription order is sent via email, API, and/or other communication protocols to the fulfillment entity. The fulfillment entity receives the prescription order and completes the order. In the example, the ostomy supplies may be mailed to the patient to fill the prescription order.

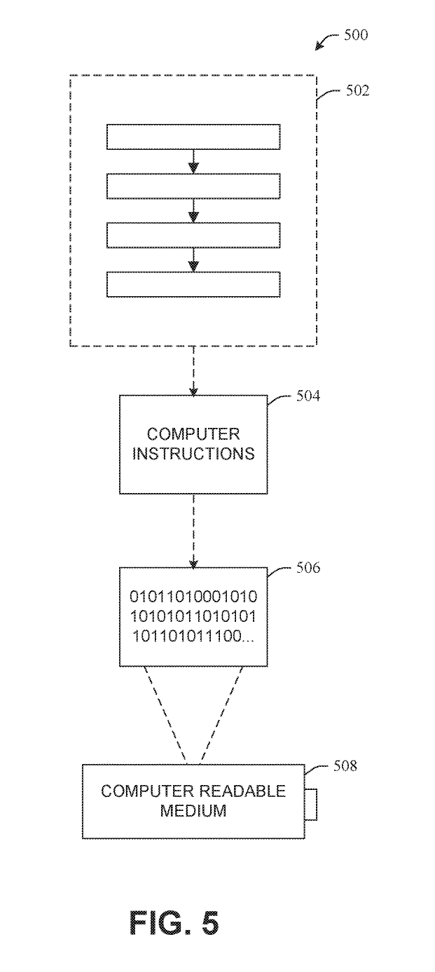

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 5, wherein an implementation 500 comprises a computer-readable medium 508, such as a CD-R, DVD-R, flash drive, a platter of a hard disk drive, etc., on which is encoded computer-readable data 506. This computer-readable data 506, such as binary data comprising a plurality of zero's and one's as shown in 506, in turn comprises a set of computer instructions 504 configured to operate according to one or more of the principles set forth herein. In one such embodiment 500, the processor-executable computer instructions 504 is configured to perform a method 502, such as at least a portion of one or more of the methods described in connection with embodiments disclosed herein. In another embodiment, the processor-executable instructions 504 are configured to implement a system, such as at least a portion of one or more of the systems described in connection with embodiments disclosed herein. Many such computer-readable media can be devised by those of ordinary skill in the art that are configured to operate in accordance with the techniques presented herein.

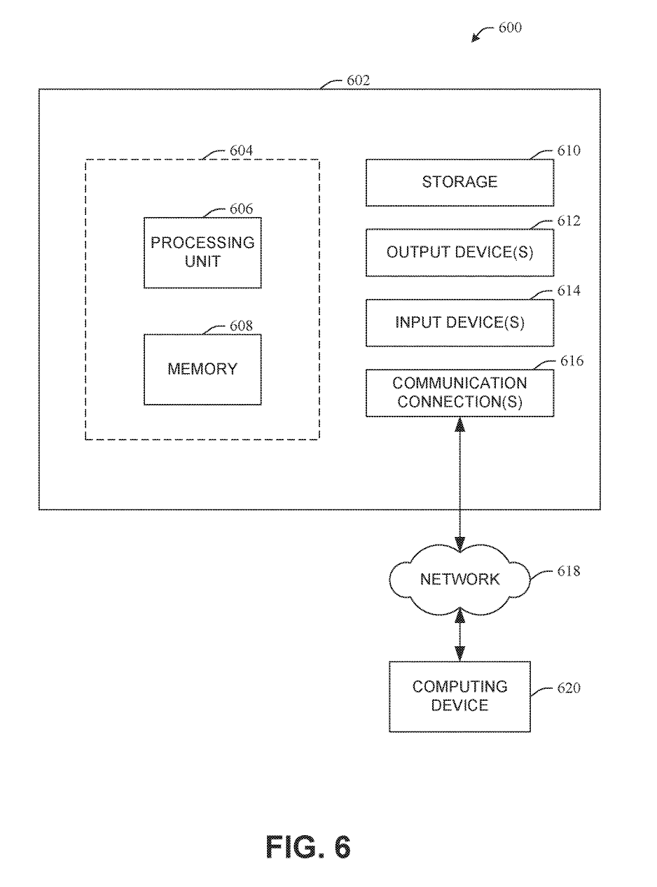

With reference to FIG. 6 and the following discussion provide a description of a suitable computing environment in which embodiments of one or more of the provisions set forth herein can be implemented. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 6 illustrates a system 600 comprising a computing device 602 configured to implement one or more embodiments provided herein. In one configuration, computing device 602 can include at least one processing unit 606 and memory 608. Depending on the exact configuration and type of computing device, memory 608 may be volatile, such as RAM, non-volatile, such as ROM, flash memory, etc., or some combination of the two. This configuration is illustrated in FIG. 6 by dashed line 604.

In these or other embodiments, device 602 can include additional features or functionality. For example, device 602 can also include additional storage such as removable storage or non-removable storage, including, but not limited to, magnetic storage, optical storage, and the like. Such additional storage is illustrated in FIG. 6 by storage 610. In some embodiments, computer readable instructions to implement one or more embodiments provided herein are in storage 610. Storage 610 can also store other computer readable instructions to implement an operating system, an application program, and the like. Computer readable instructions can be accessed in memory 608 for execution by processing unit 606, for example.

The term “computer readable media” as used herein includes computer storage media. Computer storage media includes volatile and nonvolatile, non-transitory, removable and non-removable media implemented in any method or technology for storage of information such as computer readable instructions or other data. Memory 608 and storage 610 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 602. Any such computer storage media can be part of device 602.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 602 can include one or more input devices 614 such as keyboard, mouse, pen, voice input device, touch input device, infrared cameras, video input devices, or any other input device. One or more output devices 612 such as one or more displays, speakers, printers, or any other output device can also be included in device 602. The one or more input devices 614 and/or one or more output devices 612 can be connected to device 602 via a wired connection, wireless connection, or any combination thereof. In some embodiments, one or more input devices or output devices from another computing device can be used as input device(s) 614 or output device(s) 612 for computing device 602. Device 602 can also include one or more communication connections 616 that can facilitate communications with one or more other devices 620 by means of a communications network 618, which can be wired, wireless, or any combination thereof, and can include ad hoc networks, intranets, the Internet, or substantially any other communications network that can allow device 602 to communicate with at least one other computing device 620.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
providing a prescription portal to a user;
populating a digital prescription with prescription information using the prescription portal;
generating a standardized prescription order from the digital prescription; and
communicating the standardized prescription order to a fulfillment entity.

2. The method of claim 1, wherein the prescription information includes patient information, insurance information, physician information, dispensing order information, or prescription directions.

3. The method of claim 1, comprising:
filling the prescription order in a prescription unit by the fulfillment entity; and
dispensing the prescription unit to a patient.

4. The method of claim 3, comprising:
prompting the user for a subsequent prescription order;
selecting a patient within the portal; and
auto-populating a subsequent digital prescription for the same patient.

5. The method of claim 1, comprising:
scanning medical documentation associated with the patient.

6. The method of claim 1, comprising:
integrating with an electronic medical record system to auto-populate at least part of the prescription information for the digital prescription.

7. The method of claim 1, comprising:
alerting the user of incompatible insurance that conflicts with the prescription order.

8. The method of claim 1, comprising:
associating the standardized prescription order with the patient; and
storing the standardized prescription order association in a patient prescription history database.

9. The method of claim 8, comprising:
comparing patient prescription history database for potential prescription conflicts; and
alerting the user of a found conflict.

10. The method of claim 1, comprising:
generating a notification to a patient, the notification having a copy of the prescription order;
communicating the notification to the patient over a transmission server that activates a patient device when the notification is communicated.

11. A system, comprising:
a portal component that provides a prescription portal to a user;
a population component that populates a digital prescription with prescription information using the prescription portal;
an order component that generates a standardized prescription order from the digital prescription; and
a network component that communicates the standardized prescription order to a fulfillment entity.

12. The system of claim 11, comprising:
a pharmacy component that:
fills the prescription order in a prescription unit by the fulfillment entity; and
dispenses the prescription unit to a patient.

13. The system of claim 12, comprising:
a graphical user interface that:
prompts the user for a subsequent prescription order;
selects a patient within the portal; and
wherein the population component automatically populates a subsequent digital prescription for the same patient.

14. The system of claim 11, comprising:
a records component that receives medical documentation associated with the patient.

15. The system of claim 11, comprising:
an integration component that integrates the system with an electronic medical record system to auto-populate part of the prescription information for the digital prescription.

16. The system of claim 11, comprising:
wherein the graphical user interface alerts the user of incompatible insurance that conflicts with the prescription order.

17. The system of claim 11, comprising:
a history database that:
associates the standardized prescription order with the patient; and
stores the standardized prescription order association.

18. The system of claim 17, comprising:
a comparison component that checks the digital prescription against patient prescription history for potential prescription conflicts; and
wherein the portal component alerts the user of a conflict between prescriptions.

19. The system of claim 11, comprising:
a notification component that:
generates a notification to a patient, the notification having a copy of the prescription order; and
communicates the notification to the patient over a transmission server that activates a patient device when the notification is communicated.

20. A computer readable medium having instructions to control one or more processors configured to:
provide a prescription portal to a user;
populate a digital prescription with prescription information using the prescription portal;
generate a standardized prescription order for medical supplies from the prescription information;
communicate the standardized prescription order to a fulfillment entity; and
dispense the medical supplies to a patient according to the standardized prescription order.
